(19) United States
(12) Patent Application Publication
(10) Pub. No.: US 2019/0222808 A1
(43) Pub. Date: Jul. 18, 2019

(54) INSPECTION DEVICE

(71) Applicant: DENSO CORPORATION, Kariya-city (JP)

(72) Inventors: Shinji KATO, Kariya-city (JP); Katsuhiro MIYAGAKI, Kariya-city (JP); Hiroyuki IWATSUKI, Kariya-city (JP); Masaru HORIGUCHI, Kariya-city (JP); Kohei NAKAMURA, Kariya-city (JP)

(21) Appl. No.: 16/362,874

(22) Filed: Mar. 25, 2019

Related U.S. Application Data
(63) Continuation of application No. PCT/JP2017/034898, filed on Sep. 27, 2017.

(30) Foreign Application Priority Data
Sep. 28, 2016 (JP) 2016-190104

(51) Int. Cl. H04N 7/18; H04N 5/247; G06T 7/00; G01N 21/88

(52) U.S. Cl. CPC H04N 7/185; H04N 5/247; G06T 2207/30164; G01N 21/8851; G06T 7/0004

(57) ABSTRACT

An inspection device includes a first wearable camera attached to a worker and configured to capture a relatively bright first image, a second wearable camera similarly attached to the worker and configured to capture a relatively dark second image, and a controller that functions as an inspection unit that determines the quality of a workpiece based on the first image of the workpiece captured by the first wearable camera and the second image of the workpiece captured by the second wearable camera.

### CROSS REFERENCE TO RELATED APPLICATIONS

The present application is a continuation application of International Patent Application No. PCT/JP2017/034898 filed on Sep. 27, 2017, which designated the United States and claims the benefit of priority from Japanese Patent Application No. 2016-190104 filed on Sep. 28, 2016. The entire disclosures of the above applications are incorporated herein by reference.

### TECHNICAL FIELD

The present disclosure relates to an inspection device.

### BACKGROUND

In the manufacturing process of a product, the quality of an object to be inspected such as a product at an intermediate stage (hereinafter referred to as “workpiece”) or a finished product may be visually inspected by a worker. In this case, a wearable camera may support the inspection work by capturing images.

### SUMMARY

An inspection device of the present disclosure may include a first wearable camera attached to a worker and configured to capture a relatively bright first image, a second wearable camera attached to the worker and configured to capture a relatively dark second image, and an inspection unit that determines the quality of an inspection object based on the first image of the inspection object captured by the first wearable camera and the second image of the inspection object captured by the second wearable camera.

### BRIEF DESCRIPTION OF DRAWINGS

FIG. 1 is a diagram schematically showing a schematic configuration of an inspection device according to an embodiment and an example of an inspection work to which an inspection device is applied.

FIG. 2 is a block diagram showing a configuration of an inspection device according to an embodiment.

FIG. 3 is a diagram for explaining the effects of setting the f-number of a first wearable camera to a minimum value and setting the f-number of a second wearable camera to a maximum value.

FIG. 4 is a flowchart showing the steps of an inspection process performed by an inspection device.

### DETAILED DESCRIPTION

Hereinafter, the present embodiments will be described with reference to the attached drawings. In order to facilitate the ease of understanding, the same reference numerals are attached to the same constituent elements in each drawing where possible, and redundant explanations are omitted.

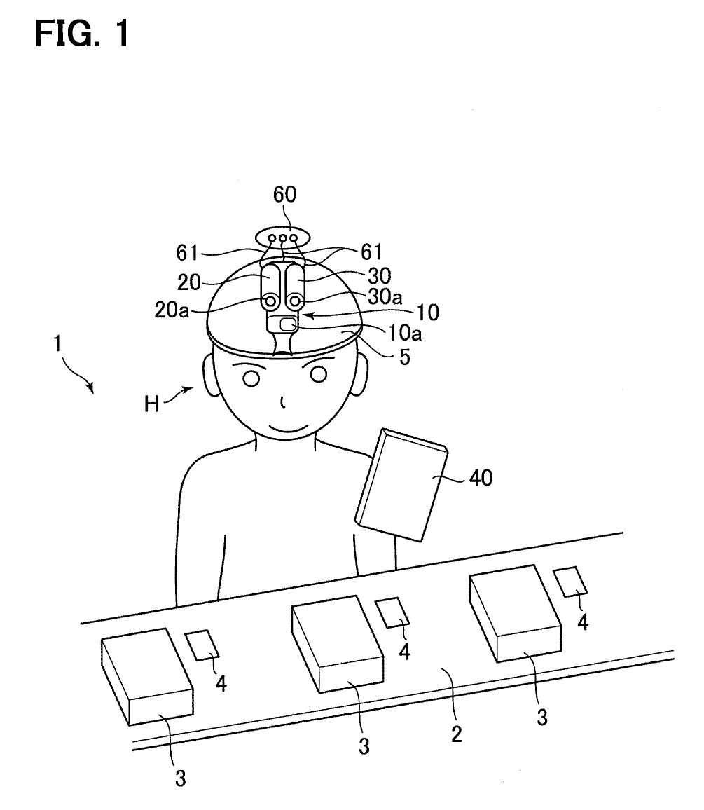

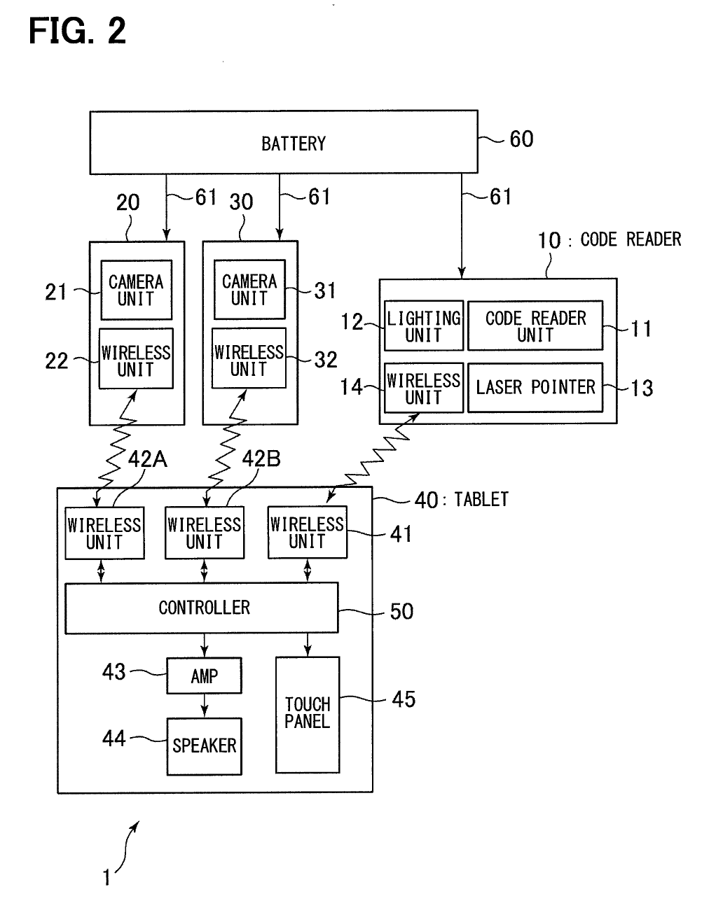

First, with reference to FIG. 1 and FIG. 2, an example of an inspection work to which an inspection device 1 according to an embodiment is applied and a schematic configuration of the inspection device 1 will be described.

The inspection device 1 according to the present embodiment is used in the manufacturing process of a product such as a heat exchanger. Specifically, the inspection device 1 is used in an inspection work for judging whether or not an object to be inspected, such as the workpiece 3 at an intermediate manufacturing stage or a finished product, are good products. As an example such inspection work, for example, the configuration shown in FIG. 1 is provided.

A worker H of the inspection work inspects whether or not the workpieces 3 sequentially conveyed by a conveyor 2 are good. The conveyor 2 carries a plurality of sets of workpieces 3 and signboards 4 and conveys these sets so that each set is positioned in front of the worker H in sequence. The signboard 4 is arranged near its corresponding workpiece 3, and a code indicating the type of the workpiece 3 is displayed on that signboard 4.

The worker H can perform the above-described inspection work using the inspection device 1 of the present embodiment. As shown in FIGS. 1 and 2, the inspection device 1 includes a code reader 10, a first wearable camera 20, a second wearable camera 30, a tablet 40, and a battery 60.

As shown in FIG. 2, the code reader 10 includes a code reader unit 11, a lighting unit 12, a laser pointer unit 13, and a wireless unit 14.

The code reader unit 11 a well known optical code reader including a light source that irradiates light. Light is emitted from the light source through lens 10a, reflected by the signboard 4, and received through the lens 10a. The code reader unit 11 reads this reflected light to read codes. Here, the signboard 4 of the present embodiment is a display board on which a code is displayed. The code is an identification indicator indicating the type of the workpiece 3. Various codes, such as a QR code (registered trademark) or a bar code, may be used as the code.

The lighting unit 12 illuminates the workpiece 3 and its surroundings through the lens 10a.

The laser pointer unit 13 irradiates a laser beam as a pointer (light spot) through the lens 10a. Thus, the laser pointer unit 13 assists the worker H to recognize a target reading area in which the code reader unit 11 reads codes. In the present embodiment, the region irradiated with the laser beam by the laser pointer unit 13 is set to coincide with the target reading area of the code reader unit 11.

The wireless unit 14 is composed of an antenna, a wireless circuit, and the like, and wirelessly communicates with the wireless unit 41 of the tablet 40.

Each of the first wearable camera 20 and the second wearable camera 30 is a compact camera which is attached to a body or the like and is intended to capture images in a hands-free manner. In the following description, the first wearable camera 20 and the second wearable camera 30 may be simply referred to as a camera 20 and a camera 30, respectively.

As shown in FIG. 2, the first wearable camera 20 includes a camera unit 21 and a wireless unit 22. The camera unit 21 captures images of the workpiece 3 as an target imaging object using the light received via lens 20a. The wireless unit 22 is composed of an antenna, a wireless circuit, and the like, and wirelessly communicates with the wireless unit 42A of the tablet 40.

Similarly, as shown in FIG. 2, the second wearable camera 30 includes a camera unit 31 and a wireless unit 32. The camera unit 31 captures images of the workpiece 3 as an target imaging object using the light received via lens 30a. The wireless unit 32 is composed of an antenna, a wireless circuit, and the like, and wirelessly communicates with the wireless unit 42B of the tablet 40.

The battery 60 is a secondary battery that supplies direct current power to the code reader 10 and the cameras 20, 30 via a harness 31 or the like.

In the present embodiment, as shown in FIG. 1, the code reader 10, the first wearable camera 20, the second wearable camera 30, and the battery 60 are mounted on a hat 5 to be work by the worker H. Further, the code reader 10, the first wearable camera 20, and the second wearable camera 30 are configured such that the lens 10a of the code reader 10, the lens 20a of the first wearable camera 20, and the lens 30a of the second wearable camera 30 are disposed to face toward the front of the worker H, and such that the lens 20a of the first wearable camera 20 and the lens 30a of the second wearable camera 30 are attached on the hat 5 of the worker H so as to be aligned substantially horizontally.

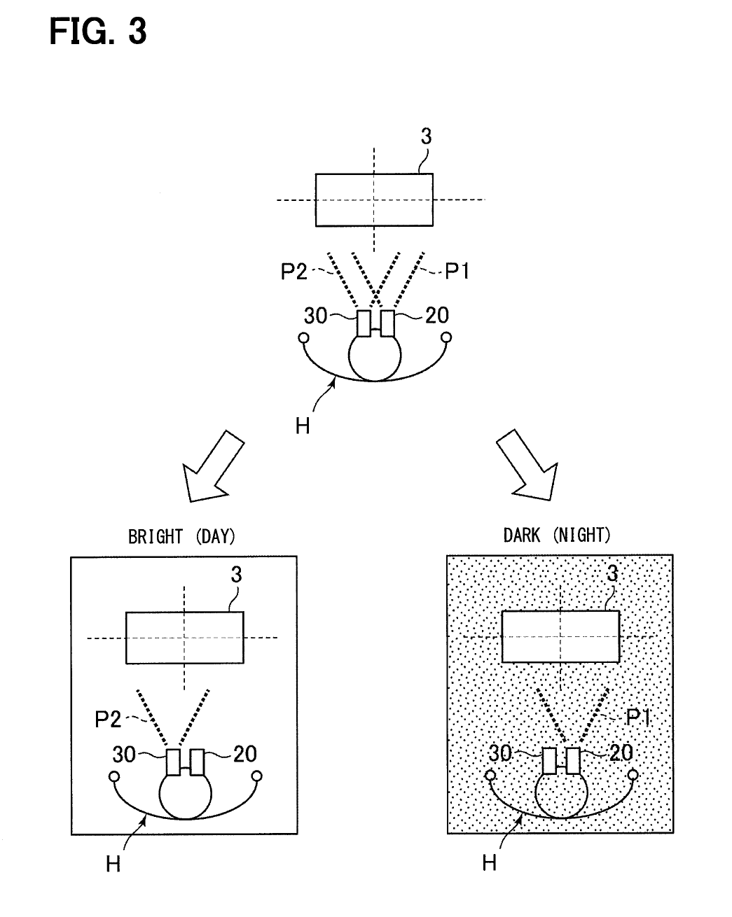

The first wearable camera 20 and the second wearable camera 30 are configured to capture images at different brightness levels as each other when the same workpiece 3 is imaged. As shown in FIG. 3, the first wearable camera 20 is configured to image a relatively bright first image P1, and the second wearable camera 30 is set to image a relatively dark second image P2. As a specific method for implementing this imaging configuration, in the present embodiment, the f-number of the first wearable camera 20 is set to be relatively small, and the f-number of the second wearable camera 30 is set to be relatively large.

Furthermore, it is desirable for the difference between the f-numbers of the first wearable camera 20 and the second wearable camera 30 to be as large as possible. Accordingly, it is preferable to set the f-number of the first wearable camera 20 to a minimum value, and set the f-number of the second wearable camera 30 to a maximum value. Here, “a state in which the f-number is a minimum value” can also be described as a state in which the aperture hole of the camera is at a maximum opening degree, or a state of maximum aperture. Further, “a state in which the f-number is a maximum value” can also be described as a state in which the aperture hole of the camera is at a minimum opening degree, or a state of minimum aperture.

Consider a case where the work environment of the inspection process is considerably dark, such as during nighttime. In such a working environment, as shown in the lower right side of FIG. 3, the second image P2 captured by the second wearable camera 30 would be too dark for the object in the image to be recognized. This is because the f-number of the second wearable camera 30 set to the maximum value. Accordingly, it is difficult to recognize the workpiece 3 in the second image P2 captured by the second wearable camera 30. In contrast, the first image P1 captured by the first wearable camera 20 in such a dark environment is at an appropriate brightness for the object in the image to be recognized. This is because the f-number of the first wearable camera 20 set to the minimum value. Accordingly, it is easy to recognize the workpiece 3 in the first image P1 captured by the first wearable camera 20. In other words, in a situation where the work environment of the inspection process is dark, the first wearable camera 20 whose f-number is set to the minimum value is superior to the second wearable camera 30 in recognizing the workpiece 3.

On the other hand, consider the case where the work environment of the inspection process is considerably bright, such as outside on a sunny day. In such a working environment, as shown in the lower left side of FIG. 3, the first image P1 captured by the first wearable camera 20 would be too bright for the object in the image to be recognized. This is because the f-number of the first wearable camera 20 set to the minimum value. Accordingly, it is difficult to recognize the workpiece 3 in the first image P1 captured by the first wearable camera 20. In contrast, the second image P2 captured by the second wearable camera 30 in such a bright environment is at an appropriate brightness for the object in the image to be recognized. This is because the f-number of the second wearable camera 30 set to the maximum value. Accordingly, it is easy to recognize the workpiece 3 in the second image P2 captured by the second wearable camera 30. In other words, in a situation where the work environment of the inspection process is bright, the second wearable camera 30 whose f-number is set to the maximum value is superior to the first wearable camera 20 in recognizing the workpiece 3.

When the working environment of the inspection process is at an intermediate brightness between the above described two patterns, as shown in the upper part of FIG. 3, both the first wearable camera 20 and the second wearable camera 30 are able to acquire images, i.e., the first image P1 and the second image P2, in which the workpiece 3 can be recognized.

In this embodiment, as described above, two opposing limit conditions are given: a condition that the work environment of the inspection process is considerably dark and the workpiece 3 can be recognized with only the first image P1 of the first wearable camera 20, and a condition that the work environment of the inspection process is considerably bright and the workpiece 3 can be recognized with only the second image P2 of the second wearable camera 30. As long as the brightness of the work environment falls between these two limit conditions, the workpiece 3 can be recognized in at least one of the captured images P1, P2 from the cameras 20, 30. Accordingly, the pass/fail determination of the workpiece 3 can be performed. That is, by providing two cameras 20, 30, the inspection device 1 of the present embodiment has a wide tolerance range for the work environment of the inspection process in which the pass/fail determination of the workpiece 3 can be performed.

Returning to FIGS. 1 and 2, the tablet 40 is a portable terminal configured to be carried by the worker H. As shown in FIG. 2, the tablet 40 includes wireless units 41, 42A, 42B, an amplifier 43, a speaker 44, a touch panel 45, and a controller 50 (inspection unit).

The wireless units 41, 42A, and 42B are composed of an antenna, a wireless circuit, and the like. The wireless unit 41 wirelessly communicates with the wireless unit 14 of the code reader 10. The wireless unit 42A wirelessly communicates with the wireless unit 22 of the first wearable camera 20. The wireless unit 42B wirelessly communicates with the wireless unit 32 of the second wearable camera 30. In the present embodiment, various types of short range wireless communications may be used for wireless communication between the wireless units. Bluetooth (registered trademark) or Wi-Fi (registered trademark) can be used as the short-range wireless communication.

The amplifier 43 amplifies the voltage of the analog signal output from the controller 50 and outputs an amplified signal. The speaker 44 converts the amplified signal output from the amplifier 43 into sound and outputs the sound. The touch panel 45 is a display device combining a transparent key input operation unit and a display panel.

The controller 50 is a device that controls the operation of each part of the inspection device 1 related to the above-described inspection work. The controller 50 is physically a microcontroller composed of a CPU, a memory, digital-analog conversion circuits, and the like. The controller 50 executes an inspection process in accordance with a computer program stored in advance in the memory. The inspection process is a determination process of determining whether or not the workpiece 3 is a non-defective product based on the code acquired from the code reader 10 and the captured images acquired by the first wearable camera 20 and the second wearable camera 30.

In the memory, a plurality of kinds of reference images are stored in advance. The reference images include still images or videos, and are used for determining whether or not the workpiece 3 is a non-defective item. Each reference image includes a non-defective product image showing a workpiece 3 which is a non-defective product and a defective product image showing a defective workpiece 3. The digital-analog conversion circuit outputs an analog signal representing a sound based on a command of the CPU.

In the present embodiment, the tablet 40 is carried by the worker H, for example, stored in a pocket of the worker H, or is placed in the vicinity of the worker H.

The inspection device 1 configured as described above is carried by the worker H as a wearable device so that both hands of the worker H are free. With the above configuration, the inspection device 1 can automatically perform the inspection work for the inspection object without requiring any operation using the hands of the worker H, and supports the inspection work of the worker H so that the burden on the worker H can be reduced. In addition, since the worker H is in a hands-free state during the inspection work, the worker H can perform other work (such as screw tightening) aside from the inspection while performing the inspection work of the workpiece 3, and efficiency can be improved.

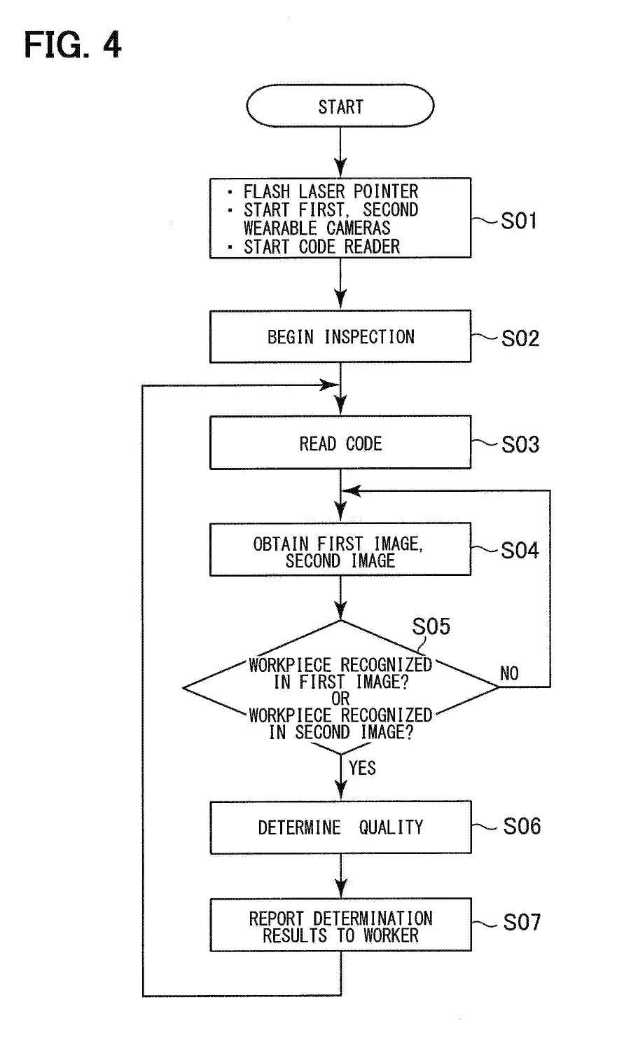

Next, with reference to FIG. 4, the operation of the inspection device 1 according to the present embodiment will be described.

In step S01, preparation for the inspection process is performed. Specifically, flashing of the laser pointer 13 is started, the first wearable camera 20 and the second wearable camera 30 are started, and the code reader 10 is started. In step S02, as the preparation in step S01 is completed, the inspection process is started.

In step S03, code reading is performed by the code reader 10. The worker H directs their head to face the signboard 4, so that the code reader 10 attached to the hat 5 reads the code from the signboard 4.

In step S04, the first wearable camera 20 acquires the first image P1 and the second wearable camera 30 acquires the second image P2. The worker H directs their head toward the workpiece 3, and the first wearable camera 20 and the second wearable camera 30, which are attached to the same hat 5 as the code reader 10, image the workpiece 3 to acquire captured images. That is, in the processing of steps S03, S04, by using the code reader 10 reading the code from the signboard 4 as a trigger, the first wearable camera 20 and the second wearable camera 30 acquire the captured image of the workpiece 3. The tablet 40, via wireless communication, receives the code from the code reader 10, receives the first image P1 from the first wearable camera 20, and receives the second image P2 from the second wearable camera 30.

In step S05, the first image P1 and the second image P2 are processed by the controller 50 in the tablet 40. Then, it is determined whether at least one condition among the following two conditions is satisfied: a condition that the workpiece 3 can be recognized in the first image P1, or a condition that the workpiece 3 can be recognized in the second image P2. As a result of the determination in step S05, when at least one condition is satisfied, that is, when the workpiece 3 can be recognized in the first image P1 or when the workpiece 3 can be recognized in the second image P2, it is determined that the pass/fail determination process for the workpiece 3 can be performed. Then, the process proceeds to step S06. Conversely, if both of the conditions are not satisfied, i.e., if the workpiece 3 can not be recognized in both the first image P1 and the second image P2, it is determined that it is impossible to perform the pass/fail determination. Then, the process returns to step S04, and steps S04 and S05 are repeated until it is determined that the workpiece 3 can be recognized in at least one of the first image P1 or the second image P2.

In step S06, as a result of the determination in step S05, since the workpiece 3 can be recognized from the first image P1 or the second image P2, the quality of the workpiece 3 is determined by the controller 50. The controller 50 selects a reference image corresponding to the received code from the plurality of types of reference images stored in advance in the memory as described previously. The controller 50 compares the first image P1 or the second image P2, in which the workpiece 3 can be recognized, with the reference image to determine whether or not the workpiece 3 is a non-defective product.

At step S07, the controller 50 notifies the worker H of the result of pass/fail determination of the workpiece 3 via sound information or visual information using the speaker 44 of the tablet 40 or the touch panel 45 of the tablet 40. After the process of step S07 is completed, the worker H continues to the next work based on the information of the determination result outputted from the tablet 40. For example, if it is determined that the workpiece 3 is a non-defective product, returning to step S03, the next workpiece 3 on the conveyor 2 is inspected.

Next, effects of the inspection device 1 according to the present embodiment will be described.

For example, consider an inspection device of a comparative example in which a recording button can be operated to capture images with a single camera in inspection work. In such inspection work, similar to the present embodiment, an inspection object is imaged using the wearable camera attached to a worker, and the inspection device is used to perform a pass or fail check on the inspection object based on the captured image of the inspection object. In the comparative example, for the above described inspection work, when a fixed camera is used, the distance and angle between the camera and the inspection object, as well as the brightness of the imaging environment, are substantially constant. As a result, the brightness of the captured images of the inspection object may be substantially uniform. However, when capturing images during an inspection work using a wearable camera, factors such as the installation position of the wearable camera or the posture of the worker affect the work environment specific to the wearable camera. As such, there may be variations in the brightness of the captured images of the inspection object. In this case, for example, there may be a situation where imaging of an inspection object necessary for the inspection process cannot be appropriately performed, e.g., if the captured image is too dark or too bright and it is impossible to extract the inspection object from the image. Using an image captured under such circumstances may degrade the accuracy of the quality determination of the inspection object. In other words, for the inspection device of the comparative example, no consideration is given to a method for appropriately capturing images according to such changes in the working environment.

Here, the inspection device 1 of the present embodiment includes the first wearable camera 20 attached to the worker H and configured to capture the relatively bright first image P1, the second wearable camera 30 similarly attached to the worker H and configured to capture the relatively dark second image P2, and the controller 50 which functions as an inspection unit 50 that determines the quality of the workpiece 3 based on the first image P1 of the workpiece 3 captured by the first wearable camera 20 and the second image P2 of the workpiece 3 captured by the second wearable camera 30.

With this configuration, the inspection target workpiece 3 is imaged with the relatively bright first image P1 and the relatively dark second image P2, and the pass/fail determination is performed on the basis of these two images P1, P2. Accordingly, even if there are variations in the brightness levels of the captured images P1, P2 due to changes in the work environment of the worker H, the effects of these variations may be absorbed so that the pass/fail determination for the workpiece 3 can be appropriately performed. As described with reference to FIG. 3, for example, when the work environment is darker than standard conditions, although the workpiece 3 may not be recognizable in the second image P2, the workpiece 3 can be recognized in the relatively bright first image P1. Accordingly, the pass/fail determination for the workpiece 3 may be performed using the first image. Further, when the work environment is brighter than standard conditions, although the workpiece 3 may not be recognizable in the first image P1, the workpiece 3 can be recognized in the relatively dark second image P2. Accordingly, the pass/fail determination for the workpiece 3 may be performed using the second image P2. That is, the range of brightness in which the pass/fail determination process can be performed is increased so as to include environments which are both darker or brighter than standard condition environments. As a result, even when the work environment changes and the brightness of the images captured by the wearable cameras 20, 30 changes, the pass/fail determination of the workpiece 3 can be appropriately performed based on the images P1, P2 captured by the wearable cameras 20, 30.

Further, in the inspection device 1 of the present embodiment, the f-number of the first wearable camera 20 is set to be relatively small, and the f-number of the second wearable camera 30 is set to be relatively large. With this configuration, since the f-number of the camera is a factor directly related to the brightness of captured images, by changing the f-numbers of the cameras, the difference between the relative brightness and the darkness of the captured images P1 and P2 of the two wearable cameras 20 and 30 can be easily and highly accurately implemented.

Further, in the inspection device 1 of the present embodiment, the f-number of the first wearable camera 20 is set to the minimum value, and the f-number of the second wearable camera 30 is set to the maximum value. With this configuration, the difference between the f-numbers of the two wearable cameras 20, 30 can be maximized. Accordingly, the difference between the brightness of the first image P1 and the darkness of the second image P2, that is, the range in which the pass/fail determination of the workpiece 3 can be performed, is maximized.

In the inspection device 1 of the present embodiment, the controller 50 performs the pass/fail determination of the workpiece 3 when the workpiece 3 can be recognized in the first image P1 or when the workpiece 3 can be recognized in the second image P2, and does not perform the pass/fail determination of the workpiece 3 when the workpiece 3 cannot be recognized in the first image P1 and cannot be recognized in the second image P2. With this configuration, the pass/fail determination for the workpiece 3 is only performed when the workpiece 3 can be recognized in the first image P1 or the second image P2. Accordingly, by avoiding performing the pass/fail determination when it is unclear whether the workpiece 3 can be recognized, inspection accuracy is improved.

The present embodiment has been described above with reference to the specific examples. However, the present disclosure is not limited to those specific examples. Those specific examples subjected to an appropriate design change by those skilled in the art are also encompassed in the scope of the present disclosure as long as the changed examples have the features of the present disclosure. Each element included in each of the specific examples described above and the placement, condition, shape, and the like of each element are not limited to those illustrated, and can be changed as appropriate. The combinations of elements included in each of the above described specific examples can be appropriately modified as long as no technical inconsistency occurs.

The details of the inspection work to which the inspection device 1 according to the embodiments described with reference to FIG. 1 and FIG. 2 are applied and the specific configurations of the inspection device 1 are merely examples and are not limited to those shown in FIGS. 1 and 2. For example, in the above described embodiments, the inspection object to be inspected for pass/fail determination is the workpiece 3 which is the product at an intermediate stage of production, but completed products can also be included.

In the above described embodiments, the first wearable camera 20 and the second wearable camera 30 are installed on the head of the worker H. However, the installation positions of these cameras 20, 30 are not limited to the head, but may be an arm portion, a hand portion, a midsection, or any arbitrary part of the body of the worker H.

In the above embodiment, a configuration in which the f-numbers are set to the minimum value and the maximum value in order to maximize the difference between the brightness levels of the images captured by the first wearable camera 20 and the second wearable camera 30 has been exemplified. However, The f-numbers are not limited to this example, as long as the two cameras 20, 30 are configured to have different f-numbers. Further, the brightness levels of the captured images of the cameras may be adjusted using factors other than the f-number, such as by using ISO or shutter speed.

1. An inspection device for use by a worker for inspection of an inspection object, comprising:
a first wearable camera attached to the worker and configured to capture a relatively bright first image;
a second wearable camera attached to the worker and configured to capture a relatively dark second image; and
an inspection unit that determines the quality of the inspection object based on the first image of the inspection object captured by the first wearable camera and the second image of the inspection object captured by the second wearable camera.

2. The inspection device according to claim 1, wherein
the f-number of the first wearable camera is set to be relatively low, and
the f-number of the second wearable camera is set to be relatively high.

3. The inspection device according to claim 2, wherein
the f-number of the first wearable camera is set to be a minimum value, and
the f-number of the second wearable camera is set to be a maximum value.

4. The inspection device according to claim 1, wherein the inspection unit is configured to:
perform the quality determination of the inspection object when the inspection object can be recognized in the first image or when the inspection object can be recognized in the second image, and
to not perform the quality determination of the inspection object when the inspection object cannot be recognized in the first image and the inspection object cannot be recognized in the second image.

5. An inspection device for use by a worker for inspection of an inspection object, comprising:
a first wearable camera configured to be attached to the worker and configured to capture a first image at a first brightness level;
a second wearable camera configured to be attached to the worker and configured to capture a second image at a second brightness level lower than the first brightness level; and
a processor coupled to the first wearable camera and the second camera, the processor being programmed to:
control the first wearable camera and the second wearable camera to image a same inspection object, and
determine the quality of the inspection object based on the first image of the inspection object captured by the first wearable camera and the second image of the inspection object captured by the second wearable camera.
